(19) United States
(12) Patent Application Publication
(10) Pub. No.: US 2011/0303542 A1
(43) Pub. Date: Dec. 15, 2011

(54) Use of Additives for Enhancing Droplet Operations

(75) Inventors: Vijay Srinivasan, Durham, NC (US); Michael G. Pollack, Durham, NC (US); Vamsee K. Pamula, Durham, NC (US); Dwayne Allen, Durham, NC (US)

(73) Assignee: ADVANCED LIQUID LOGIC, INC., Research Triangle Park, NC (US)

(21) Appl. No.: 12/672,564

(22) PCT Filed: Aug. 8, 2008
(86) PCT No.: PCT/US08/72604

§ 371 Date: Mar. 30, 2010

Related U.S. Application Data
(60) Provisional application No. 60/954,587, filed on Aug. 8, 2007.
(60) Provisional application No. 60/980,620, filed on Oct. 17, 2007.

(51) Int. Cl. G01N 27/447; B01D 57/02

(52) U.S. Cl. 204/548; 204/600; 204/450; 204/644

(57) ABSTRACT

The invention relates to a droplet actuator with a substrate comprising electrodes arranged for conducting droplet operations on a droplet operations surface of the substrate; a filler fluid phase in contact with the droplet operations surface at least partially surrounding a droplet phase comprising a droplet arranged on one or more of the electrodes, the droplet comprising: (i) a target substance susceptible to loss from the droplet phase into the filler fluid phase; and (ii) an additive which reduces loss of the target substance to the filler fluid phase relative to a corresponding droplet not comprising the additive. The invention also relates to various compositions and methods.

### RELATED PATENT APPLICATIONS

This patent application is claims priority to U.S. Patent Application No. 60/980,620, filed on Oct. 17, 2007, entitled “Use of Additives for Enhancing proplet Actuation”; and U.S. Patent Application No. 60/954,587, filed on Aug. 8, 2007, entitled “Use of additives for enhancing droplet actuation,” the entire disclosure of which is incorporated herein by reference.

### GOVERNMENT INTEREST

This invention was made with government support under HG003706-01 and DK066956-02 awarded by the National Institutes of Health of the United States. The United States Government has certain rights in the invention.

### BACKGROUND

Droplet actuators are used to conduct a wide variety of droplet operations. A droplet actuator typically includes two plates separated by a gap. The plates include electrodes for conducting droplet operations. The space is typically filled with a filler fluid that is immiscible with the fluid that is to be manipulated on the droplet actuator, so that the droplet actuator includes a droplet phase in the form of a droplet at least partially bounded by a filler fluid phase consisting of the filler fluid. The formation and movement of the droplet phase droplets is controlled by electrodes, which can be employed to conduct a variety of droplet operations. Because certain desirable components within the aqueous droplet phase may be lost during normal droplet operations to the surrounding filler fluid and/or to the proximate solid surfaces, there is a need for improved approaches to improving the retention of the desired components within a droplet.

### DEFINITIONS

As used herein, the following terms have the meanings indicated.

“Adsorption” is the loss of substances from the droplet phase to solid surfaces of the droplet actuator.

“Activate” with reference to one or more electrodes means effecting a change in the electrical state of the one or more electrodes which results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator or otherwise configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads are described in U.S. Patent Publication No. 2005-0260686, entitled, “Multiplex flow assays preferably with magnetic particles as solid phase,” published on Nov. 24, 2005, the entire disclosure of which is incorporated herein by reference for its teaching concerning magnetically responsive materials and beads. The beads may include one or more populations of biological cells adhered thereto. In some cases, the biological cells are a substantially pure population. In other cases, the biological cells include different cell populations, e.g., cell populations which interact with one another.

“Carryover” occurs when substances that are lost from the droplet phase via, for example, adsorption and/or partitioning, make their way into another droplet phase (e.g., from one droplet phase droplet to another droplet phase droplet), resulting in droplet phase cross-contamination.

“Droplet” means a volume of liquid on a droplet actuator that is at least partially bounded by filler fluid. For example, a droplet may be completely surrounded by filler fluid or may be bounded by filler fluid and one or more surfaces of the droplet actuator. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (i.e., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a splitting operation on a droplet, yielding one droplet with substantially all of the beads and one droplet substantially lacking in the beads.

“Magnetically responsive” means responsive to a magnetic field at a field strength suitable for substantially immobilizing beads on a droplet actuator. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP. “Magnetically responsive” means not significantly responsive to a magnetic field at a field strength suitable for immobilizing beads on a droplet actuator.

“Partitioning” is the transfer of substances from the droplet phase to the filler fluid phase.

“Target” substances are those substances which are usefully retained in the droplet phase, e.g., because they are analytes or reagents involved in the chemical or biochemical reactions for which the droplet actuator is intended, or because they are waste products that could contaminate the filler fluid phase.

“Washing” with respect to washing a magnetically responsive bead means reducing the amount and/or concentration of one or more substances in contact with the magnetically responsive bead or exposed to the magnetically responsive bead from a droplet in contact with the magnetically responsive bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Other embodiments are described elsewhere herein, and still others will be immediately apparent in view of the present disclosure.

Except where otherwise indicated, the terms “top” and “bottom” are used throughout the description with reference to the top and bottom substrates of the droplet actuator for convenience only, since the droplet actuator is functional regardless of its position in space.

When a given component, such as a layer, region or substrate, is referred to herein as being disposed or formed “on” another component, that given component can be directly on the other component or, alternatively, intervening components (for example, one or more coatings, layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to particular methods of material transport, deposition, or fabrication.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

Large molecular weights are generally about 1000 mw or higher. Small molecular weights are generally less than 1000. Long chains are 50 carbons (for hydrocarbons) or longer or 50 silicons (silicone based) or longer. Short chains are generally less than 50.

### DESCRIPTION

The invention provides fluids for use on droplet actuators. Droplet actuators typically employ a droplet phase (e.g., reagents, samples, etc.) and a filler fluid phase (e.g., filler fluids). The invention provides modified fluids for use in one or both of these phases. The modifications of the invention have a variety of improved attributes relative to existing fluids. For example, in certain embodiments, the modified fluids reduce (relative to corresponding fluids lacking the modifications described herein) or minimize or substantially eliminate loss of target substances from the hydrophilic phase due, for example, to the effects of adsorption and/or partitioning of target substances. Further, in certain embodiments, the modified fluids reduce (relative to corresponding fluids lacking the modifications described herein) or minimize or substantially eliminate carryover of target substances. The improved target substance retention is achieved without substantial reduction in the capability of the droplets to be subjected to one or more droplet operations on a droplet actuator of the invention.

The invention thus provides droplet phase and filler fluid phase fluids including certain additives. The additives may improve retention of target substances in the droplet phase and/or reduce loss of target substances in the droplet phase. Further, the invention provides droplet actuators including the modified droplet phase and/or filler fluid phase fluids of the invention. Further, the invention provides methods of conducting droplet operations using such modified droplet phase and/or filler fluid phase fluids of the invention, which methods exhibit improved retention of target substances in the droplet phase and/or reduced loss of target substances in the droplet phase relative to corresponding fluids lacking the additives described herein.

As will be discussed in more detail in the ensuing sections, a method of using additives for enhancing droplet actuation includes, but is not limited to, the steps of (1) reducing adsorption, such as by adding an additive to the droplet phase and/or filler fluid phase in order to render one or more target components less likely to adsorb to surfaces of the droplet actuator, (2) reducing partitioning, such as by adding an additive to the droplet phase and/or filler fluid phase in order to reduce the partitioning of one or more target components into the filler fluid phase, (3) reducing carryover, such as by adding an additive to the droplet phase and/or filler fluid phase in order to reduce the carryover of one or more target components from one droplet phase to another droplet phase, and (4) any combinations of (1), (2), and (3).

### 5.1 Aqueous-Soluble Additives

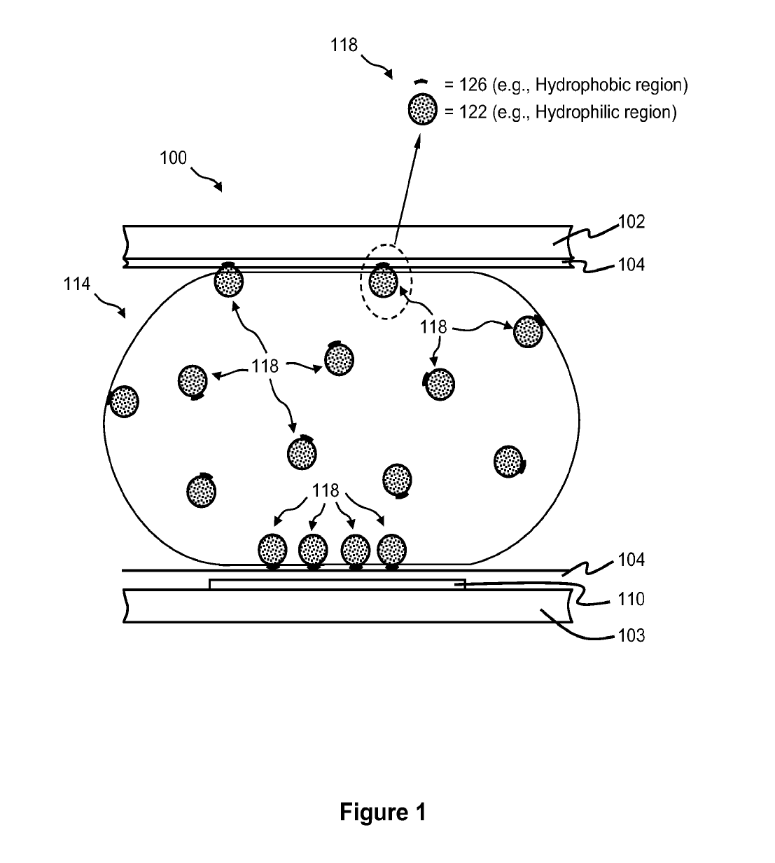

FIG. 1 illustrates a side view of a droplet actuator 100. Droplet actuator 100 includes a top plate 102 and a bottom plate 103 separated to form a gap in which the droplet phase is illustrated as a droplet 114. Droplet 114 is surrounded with a filler fluid phase (not illustrated). The top and or bottom plate may include electrodes 110. The top and bottom plates typically include a hydrophobic coating 104, and may include one or more electrodes 110 for performing droplet operations. Droplet 114 includes droplet phase components 118 which are susceptible to loss from the droplet phase. For example, in one embodiment, component 118 is substantially composed of a hydrophilic region 122, and may include one or more hydrophobic regions 126. Many known compounds, such as proteins and/or peptides and PEG-alkyl polymers, have these characteristics. Other examples include beads and particles. The hydrophobic region 126 of the droplet phase substance 118 may adsorb to the hydrophobic coating 104, particularly at the surface of electrodes 110.

Referring again to FIG. 1, the problem of adsorption may be summarized as follows. FIG. 1 shows that hydrophobic regions 126 of certain respective droplet phase components 118 may be oriented toward the outer surface of droplet 114 in a manner that is prone to adsorption when in contact with or proximity to the hydrophobic coating 104 at electrode 110. Consequently, components 118 are lost from droplet 114 due to adsorption, thereby changing its composition, which is not desired. It should be noted that a side effect of the problem of adsorption is the fouling of the droplet operations surface, which may interfere with subsequent droplet operations on the same or other instances of the droplet phase. Filler fluid phase partitioning of such components may also be more likely due to the interaction of the hydrophobic region 126 with the filler fluid phase.

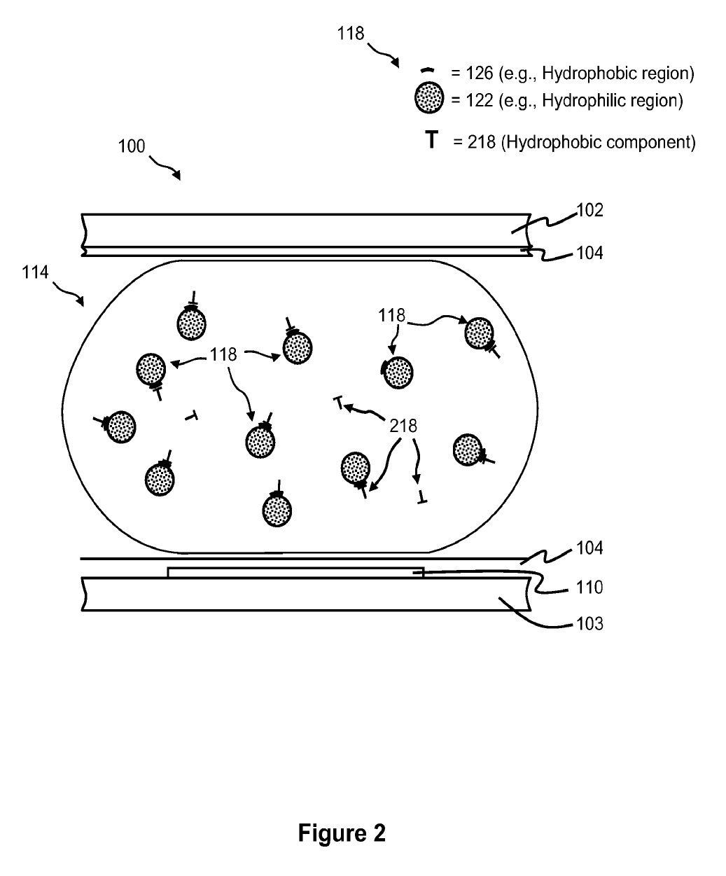

FIG. 2 illustrates a side view of the droplet actuator 200 that components as described with respect to FIG. 1. Additionally, droplet 114 includes an aqueous-soluble additive 218. Aqueous-soluble additive 218 may, for example, include a hydrophobic region and a hydrophilic region. The hydrophobic region may associate with the hydrophobic region of component 118, while the hydrophilic region may render the additive 218 relatively water soluble. Aqueous-soluble component 218 may be an aqueous-soluble additive that provides a hydrophobic component that interacts with hydrophobic regions 126 of droplet phase components 118 in order to yield a complex including the component 118 and additive 218 having a water solubility in the aqueous medium that is greater than the water solubility of the component 118 in the absence of the additive 218.

In one example, additive 218 is an aqueous soluble substance that has a hydrophile-lipophile balance (HLB) in the range of about 10 to about 20, and in a preferred embodiment in the range of about 15 to about 20. Examples of suitable components having an HLB in the range of about 15 to about 20 include, but are not limited to, polysorbate 20, which is commercially available as Tween® 20, and Triton X-100. Tween® 20 may be supplied by, for example, Pierce Biotechnology, Inc. (Woburn, Mass.). Triton® X-100 may be supplied by, for example, Rohm & Haas Co (Philadelphia, Pa.). Additive 218 may be selected to provide a hydrophobic region that interacts with hydrophobic regions 126 of droplet phase components 118 in order to yield a complex including the component 118 and additive 218.

The aqueous-soluble additive 218 may selected and provided in an amount sufficient to interfere with adsorption, partitioning and/or carryover to the extent that the adsorption, partitioning and/or carryover is reduced relative to the adsorption, partitioning and/or carryover of the component 118 in the absence of the additive 218.

In some embodiments, the additive 218 may be provided in an amount sufficient to yield an additive 218-component 118 complex having:

(a) a water solubility in the aqueous medium that is greater than the water solubility of the component 118 in the absence of the additive 218, and/or

(b) a tendency to adsorb to surfaces that is less than the tendency of the component 118 in the absence of the additive 218, and/or

(c) a tendency to partition into the filler fluid phase that is less than the tendency of the component 118 in the absence of the additive 218; and/or

(d) a tendency to carry over from one droplet phase into another droplet phase via the filler fluid phase that is less than the tendency of the component 118 in the absence of the additive 218.

In some embodiments, the tendency of the component 118 to adsorb, partition and/or carryover is reduced to a degree that is sufficient to prevent the adsorbtion, partition and/or carryover from rendering the droplet actuator unsuitable for its intended purpose. In other embodiments, the tendency of the component 118 to adsorb, partition and/or carryover is substantially eliminated.

In one embodiment when additive 218 includes Tween® 20. The concentration of Tween® 20 in the droplet phase may, for example, be in the range of from about 001% to about 0.2% by volume, or from about 0.005% to about 0.1% by volume, or from about 0.01% to about 0.08% by volume.

In one embodiment, additive 218 includes Triton X-100. The concentration of Triton X-100 in the droplet phase may, for example, be in the range of from about 0.001% to about 0.2% by volume, or from about 0.005% to about 0.1% by volume, or from about 0.01% to about 0.08% by volume.

In another example, the additive may be an organic solvent, such as dimethyl sulfoxide (DMSO) supplied by Gaylord Chemical Corporation (Slidell, La.). The concentration of DMSO in the droplet phase may, for example, be in the range of from about 0.01% to about 5% by volume, or from about 0.1% to about 2% by volume, or from about 0.5% to about 1% by volume.

In yet another example, aqueous-soluble component 514 may be a combination of DMSO and Triton X-100 in concentrations as described above.

A variety of additives may be added to the droplet phase to improve droplet operations by increasing solubility of the target. Examples include 1,3-propanediol; 1,4-butanediol; 1,5-pentanediol; 2,2,2-trifluoroethanol; 2-propanol; 3-mercaptopropionic acid; acetic acid; butyl chloride; chloroform (with ethanol, e.g., 1% ethanol); diethylene glycol; dimethyl sulfoxide; dimethylformamide; ethanol; ethylene glycol; formamide; formic acid; glycerol; isoamyl alcohol; mercaptoethanol; methanol; N,N-dimethlyformamide; N-methlyacetamide; phenol; pyridine; triethanolamine; triethylene glycol; and trifluoroacetic acid. Preferred organic solvent additives are those in which the target has a solubility which is greater than about 10 mg/mL.

Still other suitable additives include partially fluorinated surfactants, such as 1H,1H,2H,2H-perfluoro-1-decanol and 1H,1H,2H,2H-perfluoro-1-octanol; as well as perfluorinated surfactants, such as perfluorodecanoic acid and perfluorododecanoic acid.

An important class of additives for use in the droplet fluid phase is aqueous soluble fluorinated surfactants. A list of fluorinated surfactants is available in Chapter 1 “Fluorinated Surfactants and Repellents” By Erik Kissa, Published by CRC Press, 2001, the entire disclosure of which is incorporated herein by reference. Other suitable fluorinated surfactants are described in Michael Terrazas & Rudi Dams, “A new generation of fluorosurfactants,” Speciality Chemicals Magazine, March 2004, vol 24 no 3, the entire disclosure of which is incorporated herein by reference.

Combinations of any of the foregoing surfactants may be used as filler fluid phase additives in accordance with the invention. Further, combinations of organic solvents, as well as combinations of any water miscible solvents with water may also be used in accordance with the invention. Moreover, combinations of foregoing surfactants and organic solvent additives may be used.

The invention also provides a droplet actuator, such as droplet actuator 200, having one or more aqueous droplets including one or more additives selected and provided in an amount which reduces the loss of target substances due to adsorption and/or partitioning. The invention also includes a method of conducting a droplet operation during which operation the droplet includes one or more additives selected and provided in an amount that reduces the loss of target substances due to adsorption and/or partitioning.

### 5.2 Oil Soluble Additives

In addition to, or as an alternative to, the water soluble additives described above, certain oil soluble additives may be useful in the filler fluid phase for reducing loss of target droplet phase components from the droplet phase. Examples of suitable additives include nonionic low HLB (hydrophile-lipophile balance) surfactants. The HLB is preferably less than about 10 or less than about 5. Suitable examples include: Triton X-15 (HLB=4.9); Span 85 (HLB 1.8); Span 65 (2.1); Span 83 (3.7); Span 80 (4.3); Span 60 (4.7); and fluorinated surfactants.

For example, oil-soluble filler fluid additives may include Span-85 (sorbitan trioleate) and/or Triton® X-15. Span-85 may be supplied by, for example, Merck Schuchardt OHG (Germany). Triton® X-15 may be supplied by, for example, Rohm & Haas Co (Philadelphia, Pa.).

Filler fluid additives are preferably selected and provided in an amount which (1) enables the droplet actuator to conduct or repeat more droplet operations compared to corresponding droplet actuator without the additives; and/or (2) enables one or more droplet operations on the droplet actuator that are not possible on a corresponding droplet actuator without the additives; and/or (3) makes one or more droplet operations more reliable on the droplet actuator as compared to corresponding droplet actuator without the additives; and/or (4) results in less loss of target substance from the droplet phase during droplet operations as compared to a corresponding droplet operations in the absence of the additives.

In a related example, surfactant(s) are selected and provided in an amount which makes one or more droplet operations possible or more reliable for droplets including one or more specific reagents or mixtures on the droplet actuator as compared to droplet operations for the same droplets including one or more specific reagents or mixtures on a corresponding droplet actuator without the surfactant(s). In another related example, surfactant(s) are selected and provided in an amount which makes one or more droplet operations possible or more reliable for one or more droplets including amphiphilic molecules on the droplet actuator as compared to droplet operations for the same droplets including amphiphilic molecules on a corresponding droplet actuator without the surfactant(s).

In one example, the concentration of Span-85 in the filler fluid phase is about 0.05% by volume. In yet another example, the concentration of Triton® X-15 in the filler fluid phase is in the range of about 0.05% to about 0.1% by volume. In yet another example, the concentration of Triton® X-15 in the filler fluid phase is about 0.2% by volume.

In another embodiment when the filler fluid phase additive includes Triton X-15. The concentration of Triton X-15 in the filler fluid phase may, for example, be in the range of from about 0.001% to about 0.3% by volume, or from about 0.005% to about 0.2% by volume, or from about 0.05% to about 0.2% by volume.

An important class of additives for use in the filler fluid phase is oil soluble fluorinated surfactants. A comprehensive list of fluorinated surfactants is available in Chapter 1 “Fluorinated Surfactants and Repellents” By Erik Kissa, Published by CRC Press, 2001, the entire disclosure of which is incorporated herein by reference.

In other embodiment, the filler fluid phase additive includes surfactants with oleophilic & hydrophilic groups. The oleophilic groups may, for example, be hydrocarbon or silicone based. In one embodiment, the surfactant has an HLB which is less than about 5 and a small hydrophilic group. In another embodiment, the surfactant has a long hydrophobic(oleophilic) chains, e.g., polymeric surfactants, such as silicone polymeric surfactants.

In yet another embodiment, the surfactants include oleophobic, oleophilic and hydrophilic groups. For example, the oleophobic groups may include fluorinated groups. The oleophilic groups may include hydrocarbon/silicone groups. In one embodiment, the surfactant has a short or low mw hydrophilic group. In another embodiment, the surfactant has a short or low mw fluorinated group. In one embodiment, the surfactant has a short or low mw hydrophilic group and a long or high mw hydrophobic or oleophilic group. In yet another embodiment, the surfactant has a short or low mw fluorinated group and a long or high mw hydrophobic or oleophilic group. In certain embodiments, such as semifluorinated alkanes, the surfactant may lack a hydrophilic group. Further, certain surfactants suitable for use in the present invention lack a hydrophilic group and include a short fluorinated group or a short fluorinated group with a long hydrophobic group. As described herein, short fluorines have generally 20 or less, 15 or less, or 10 or less fluorinated groups (eg —CF₂— or CF₃—). In one embodiment, the surfactant is a fluorosilicone.

Silicone surfacants may be used as filler fluid additives in accordance with the invention. Examples include DBE-224, DBE-621, and ABP-263, manufactured by Gelest.

Hydrocarbon surfactants are also suitable additives for the filler fluid phase. Examples include Tetronic 701, Tetronic 901, Tetronic 70R2, Tetronic 150R4, Tetronic 110R1, Tetronic 1301, Tetronic 150R1, Tetronix 1502, Pluronic 25R1, Pluronic L101, Pluronic L61, Pluronic L81, Plurafac A-24, by BASF; IGEPAL CA-210 and IGEPAL CO-210 by GEF; and SPAN 60, SPAN 65, SPAN 80, SPAN 85, ARLACEL 60, ARLACEL 83, BRIJ 52, BRIJ 93, ATMUL 500, ARSURF 2802, by ICI.

Fluorinated surfactants are also useful as additives to the filler fluid phase, e.g., PolyFox PF-636, 6320, 656, 6520, 651, 652 by Omnova; Masurf FS-910, FS-1400, FS-1900 by Mason Chemical Company; FC-4432 by 3M; FMS-141, FMS-736, FMS-121 (all examples of fluorosilicones) by Gelest; Zonyl 8857 and Zonyl FTS by Dupont; and fluorinated surfactants without hydrophilic groups.

Combinations of any of the foregoing surfactants may be used as droplet phase additives in accordance with the invention.

### 5.3 Changing pH to Adjust Solubility

The invention includes a droplet actuator having a droplet thereon having a target substance therein, where the droplet has a pH which has been adjusted away from the isoelectric point of the target substance in order to increase the solubility of the target substance. Similarly, the invention provides a method for preparing a fluid for conducting one of more droplet operations on a droplet actuator, where the method comprises adjusting the pH of the fluid in a direction which is away from the isoelectric point of the target substance in order to increase the solubility of the target substance. The adjustment may, for example, be achieved by combining the droplet with another droplet having a different pH. The invention further includes methods of conducting droplet operations, where the droplet operations are conducted using a droplet in which the pH has been adjusted as described here. The droplet having the adjusted pH may be wholly or partially surrounded by a filler fluid while present on the droplet actuator and/or while undergoing droplet operations.

Another aspect of the invention relates to changing the pH of a droplet in order to increase retention of a target substance in the droplet. For example, a first droplet having a target substance and a first pH may be combined with a second droplet having a second pH which is different from the fist pH. When the first droplet and second droplet are combined using one or more droplet operations, the resulting combined droplet has a pH which is adjusted relative to the pH of the first droplet. In one aspect of the invention, the pH of the second droplet is selected so that the pH of the first droplet will be adjusted in a direction which is which is away from the isoelectric point of the target substance.

### 5.4 Droplet Actuator

For examples of droplet actuator architectures that are suitable for use with the present invention, see U.S. Pat. No. 6,911,132, entitled, “Apparatus for Manipulating Droplets by Electrowetting-Based Techniques,” issued on Jun. 28, 2005 to Pamula et al.; U.S. patent application Ser. No. 11/343,284, entitled, “Apparatuses and Methods for Manipulating Droplets on a Printed Circuit Board,” filed on filed on Jan. 30, 2006; U.S. Pat. Nos. 6,773,566, entitled, “Electrostatic Actuators for Microfluidics and Methods for Using Same,” issued on Aug. 10, 2004 and 6,565,727, entitled, “Actuators for Microfluidics Without Moving Parts,” issued on Jan. 24, 2000, both to Shenderov et al.; Pollack et al., International Patent Application No. PCT/US 06/47486, entitled, “Droplet-Based Biochemistry,” filed on Dec. 11, 2006, the disclosures of which are incorporated herein by reference. Examples of droplet actuator techniques for immobilizing magnetic beads and/or non-magnetic beads are described in the foregoing international patent applications and in Sista, et al., U.S. Patent Application Nos. 60/900,653, filed on Feb. 9, 2007, entitled “Immobilization of magnetically-responsive beads during droplet operations”; Sista et al., U.S. Patent Application No. 60/969,736, filed on Sep. 4, 2007, entitled “Droplet Actuator Assay Improvements”; and Allen et al., U.S. Patent Application No. 60/957,717, filed on Aug. 24, 2007, entitled “Bead washing using physical barriers,” the entire disclosures of which is incorporated herein by reference.

### 5.5 Droplet Phase Fluids

For examples of droplet phase fluids that may subjected to droplet operations according to the invention, see the patents listed in section 5.4, especially International Patent Application No. PCT/US 06/47486, entitled, “Droplet-Based Biochemistry,” filed on Dec. 11, 2006. In some embodiments, the droplet phase includes a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, fluidized tissues, fluidized organisms, biological swabs and biological washes. In some embodiment, the droplet phase includes a reagent, such as water, deionized water, saline solutions, acidic solutions, basic solutions, detergent solutions and/or buffers. In some embodiments, the droplet phase includes a reagent, such as a reagent for a biochemical protocol, such as a nucleic acid amplification protocol, an affinity-based assay protocol, a sequencing protocol, and/or a protocol for analyses of biological fluids. The droplet phase fluid may be provided in the form of a droplet.

### 5.6 Filler Fluid Phase Fluids

The filler fluid phase may, for example, be a low-viscosity oil, such as silicone oil. Other examples of filler fluids are provided in International Patent Application No. PCT/US 06/47486, entitled, “Droplet-Based Biochemistry,” filed on Dec. 11, 2006.

This specification is divided into sections for the convenience of the reader only. Headings should not be construed as limiting of the scope of the invention.

It will be understood that various details of the present invention may be changed without departing from the scope of the present invention. Various aspects of each embodiment described here may be interchanged with various aspects of other embodiments. Furthermore, the foregoing description is for the purpose of illustration only, and not for the purpose of limitation.

We claim:

1. A droplet actuator comprising:
(a) a substrate comprising electrodes arranged for conducting droplet operations on a droplet operations surface of the substrate;
(b) a filler fluid phase in contact with the droplet operations surface at least partially surrounding a droplet phase comprising a droplet arranged on one or more of the electrodes, the droplet comprising:
(i) a target substance susceptible to loss from the droplet phase into the filler fluid phase; and
(ii) an additive which reduces loss of the target substance to the filler fluid phase relative to a corresponding droplet not comprising the additive.

2. The droplet actuator of claim 1 wherein the filler fluid phase comprises multiple fluids immiscible with the droplet phase.

3. The droplet actuator of claim 1 wherein the target substance comprises a hydrophobic region.

4. The droplet actuator of claim 1 wherein the target substance comprises a protein and/or peptide.

5. The droplet actuator of claim 1 wherein the target substance comprises a bead.

6. The droplet actuator of claim 1 wherein the target substance comprises a biological cell.

7. The droplet actuator of claim 1 wherein the additive comprises a hydrophobic region that interacts with the target substance.

8. The droplet actuator of claim 1 wherein:
(a) the additive comprises a hydrophobic region and a hydrophilic region, and
(b) the hydrophobic region interacts with the target substance.

9. The droplet actuator of claim 1 wherein the additive complexes with the target substance reducing its affinity for the filler fluid phase.

10. The droplet actuator of claim 9 wherein the complexing produces a complex having a water solubility in the aqueous medium that is greater than the water solubility of the target substance in the absence of the additive.

11. The droplet actuator of claim 9 wherein the complexing produces a complex having a tendency to adsorb to surfaces that is less than the tendency of the target complex to adsorb to surfaces in the absence of the additive.

12. The droplet actuator of claim 9 wherein the complexing produces a complex having a tendency to partition into the filler fluid phase that is less than the tendency of the target substance to partition into the filler fluid phase in the absence of the additive.

13. The droplet actuator of claim 9 wherein the complexing produces a complex having a tendency to carry over from one droplet phase into another droplet phase via the filler fluid phase that is less than the tendency of the target substance to carry over from one droplet phase into another droplet phase via the filler fluid phase in the absence of the additive.

14. The droplet actuator of claim 1 wherein the additive is selected to provide a hydrophobic region that interacts with hydrophobic regions of the target substance in order to yield a complex including the target substance and the additive.

15. The droplet actuator of claim 9 wherein the additive complexes with the target substance, yielding a complex having a water solubility in the aqueous medium that is greater than the water solubility of the target substance in the absence of the additive.

16. The droplet actuator of claim 1 wherein the additive has an HLB in the range of about 10 to about 20.

17. The droplet actuator of claim 1 wherein the additive has an HLB in the range of about 15 to about 20.

18. The droplet actuator of claim 1 wherein the additive is selected from the group consisting of: polysorbate 20 and Triton X-100.

19. The droplet actuator of claim 1 wherein the additive is selected from the group consisting of: 1,3-propanediol; 1,4-butanediol; 1,5-pentanediol; 2,2,2-trifluoroethanol; 2-propanol; 3-mercaptopropionic acid; acetic acid; butyl chloride; chloroform (with ethanol, e.g., 1% ethanol); diethylene glycol; dimethyl sulfoxide; dimethylformamide; ethanol; ethylene glycol; formamide; formic acid; glycerol; isoamyl alcohol; mercaptoethanol; methanol; N,N-dimethlyformamide; N-methlyacetamide; phenol; pyridine; triethanolamine;
triethylene glycol; and trifluoroacetic acid.

20. The droplet actuator of claim 1 wherein the additive comprises polysorbate 20 in the range of from about 0.001% to about 0.2% by volume.

21. The droplet actuator of claim 1 wherein the additive comprises polysorbate 20 in the range of from about 0.005% to about 0.1% by volume

22. The droplet actuator of claim 1 wherein the additive comprises polysorbate 20 in the range of from about 0.01% to about 0.08% by volume.

23. The droplet actuator of claim 1 wherein the additive comprises Triton X-100 in the range of from about 0.001% to about 0.2% by volume.

24. The droplet actuator of claim 1 wherein the additive comprises Triton X-100 in the range of from about 0.005% to about 0.1% by volume.

25. The droplet actuator of claim 1 wherein the additive comprises Triton X-100 in the range of from about 0.01% to about 0.08% by volume.

26. The droplet actuator of claim 1 wherein the additive is provided in an amount sufficient to interfere with adsorption, partitioning and/or carryover of the target substance.

27. The droplet actuator of claim 1 wherein the additive is provided in an amount sufficient to reduce adsorption, partitioning and/or carryover relative to the adsorption, partitioning and/or carryover of the target substance in the absence of the additive.

28. The droplet actuator of claim 1 wherein the additive is provided in an amount sufficient to substantially eliminate adsorption, partitioning and/or carryover of the target substance.

29. A method of reducing electrode fouling by a target substance in a droplet at least partially surrounded by a filler fluid phase on a droplet actuator, the method comprising including in the droplet an additive which reduces loss of the target substance into the filler fluid phase relative to a corresponding droplet not comprising the additive.

30. The method of claim 29 wherein the additive increases solubility of the target substance.

31. A method of conducting a droplet operation, the method comprising
(a) providing a droplet actuator comprising:
(i) a substrate comprising electrodes arranged for conducting droplet operations on a droplet operations surface of the substrate; and
(ii) filler fluid phase on the droplet operations surface at least partially surrounding a droplet phase comprising a droplet arranged on one or more of the electrodes, the droplet comprising:
(1) a target substance susceptible to loss from the droplet phase into the filler fluid phase; and
(2) an additive which reduces loss of the target substance to the filler fluid phase relative to a corresponding droplet not comprising the additive;
(iii) using one or more of the electrodes to conduct a droplet operation on the droplet.

32. A droplet actuator comprising:
(a) a substrate comprising electrodes arranged for conducting droplet operations on a droplet operations surface of the substrate; and
(b) filler fluid phase on the droplet operations surface at least partially surrounding a droplet phase comprising a droplet arranged on one or more of the electrodes, wherein:
(i) the droplet comprises a target substance susceptible to loss from the droplet phase into the filler fluid phase; and
(ii) the filler fluid phase comprises an additive which reduces loss of the target substance to the filler fluid phase relative to loss of the target substance in the absence of the additive.

33. The droplet actuator of claim 32 wherein the target substance comprises a hydrophobic region.

34. The droplet actuator of claim 32 wherein the target substance comprises a protein and/or peptide.

35. The droplet actuator of claim 32 wherein the target substance comprises a bead.

36. The droplet actuator of claim 32 wherein the target substance comprises a biological cell.

37. The droplet actuator of claim 32 wherein the additive comprises a nonionic low HLB surfactant.

38. The droplet actuator of claim 37 wherein the HLB is less than about 10.

39. The droplet actuator of claim 37 wherein the HLB is less than about 5.

40. The droplet actuator of claim 32 wherein the additive is selected from the group consisting of: Triton X-15, Span 85, Span 65, Span 83, Span 80, Span 60, and fluorinated surfactants.

41. The droplet actuator of claim 32 wherein the additive comprises a combination of two or more additives selected from the group consisting of Triton X-15, Span 85, Span 65, Span 83, Span 80, Span 60, and fluorinated surfactants.

42. The droplet actuator of claim 32 wherein the additive is selected in provided in an amount which results in more droplet operations on the droplet actuator as compared to corresponding droplet actuator without the additive.

43. The droplet actuator of claim 32 wherein the additive is selected in provided in an amount which makes one or more droplet operations possible on the droplet actuator as compared to possible droplet operations on a corresponding droplet actuator without the additive.

44. The droplet actuator of claim 32 wherein the additive is selected in provided in an amount which makes one or more droplet operations more reliable on the droplet actuator as compared to reliability of the droplet operations on a corresponding droplet actuator without the additive.

45. The droplet actuator of claim 32 wherein the additive is selected in provided in an amount which results in reduced loss of target substance from the droplet phase during droplet operations as compared to loss of target substance on a corresponding droplet operations in the absence of the additive.

46. The droplet actuator of claim 32 wherein the additive comprises a surfactant selected in provided in an amount which makes one or more droplet operations possible or more reliable for droplets including one or more specific reagents or mixtures on the droplet actuator as compared to droplet operations for the same droplets including one or more specific reagents or mixtures on a corresponding droplet actuator without the additive.

47. The droplet actuator of claim 32 wherein the additive comprises a surfactant selected and provided in an amount which in an amount which makes one or more droplet operations possible or more reliable for one or more droplets including amphiphilic molecules on the droplet actuator as compared to droplet operations possible for the same droplets including amphiphilic molecules on a corresponding droplet actuator without the surfactant.

48. The droplet actuator of claim 32 wherein the additive comprises Span-85 at about 0.05% by volume.

49. The droplet actuator of claim 32 wherein the additive comprises Triton X-15 in a range of about 0.001% to about 0.3% by volume.

50. The droplet actuator of claim 32 wherein the additive comprises Triton X-15 in a range of about 0.005% to about 0.2% by volume.

51. The droplet actuator of claim 32 wherein the additive comprises Triton X-15 in a range of about 0.05% to about 0.2% by volume.

52. A droplet actuator comprising a droplet thereon, the droplet comprising a target substance therein, wherein the droplet has a pH which has been adjusted away from the isoelectric point of the target substance thereby increasing the solubility of the target substance.

53. A method for providing a droplet on a droplet actuator, the method comprising:
(a) providing a fluid:
(i) comprising a target substance having an isoelectric point; and
(ii) having a certain pH;
(b) adjusting the pH of the fluid in a direction which is away from the isoelectric point of the target substance to yield a pH-adjusted droplet;
(c) providing a droplet actuator comprising:
(i) a substrate comprising:
(1) a droplet operations surface;
(2) electrodes arranged for conducting droplet operations on the droplet operations surface;
(d) providing the pH-adjusted droplet on the droplet actuator.

54. The method of claim 53 wherein step 53(d) comprises:
(a) loading the fluid in a reservoir on the droplet actuator;
(b) using the electrodes to dispense a droplet from the reservoir.

55. The method of claim 53 wherein step 53(b) is conducted using droplet operations on a droplet actuator.

56. The method of claim 53 for the comprising using the droplet to conduct one or more droplet operations mediated by the electrodes.

57. The method of claim 55 wherein the droplet is wholly or partially surrounded by a filler fluid phase.
